(19) United States
(12) Patent Application Publication
(10) Pub. No.: US 2016/0179458 A1
(43) Pub. Date: Jun. 23, 2016

(54) DIGITAL SIGNAL PROCESSING USING A COMBINATION OF DIRECT AND MULTI-BAND CONVOLUTION ALGORITHMS IN THE TIME DOMAIN

(71) Applicant: Fractal Audio Systems, Plaistow, NH (US)

(72) Inventor: Clifford Chase, Plaistow, NH (US)

(21) Appl. No.: 14/579,201

(22) Filed: Dec. 22, 2014

(51) Int. Cl. G06F 3/16

(52) U.S. Cl. CPC G06F 3/165

(57) ABSTRACT

The specification relates to the processing of a digital input signal. The digital input signal is convolved with a first time slice of an impulse response with a first direct convolution filter. In parallel, the digital input signal is divided into multiple frequency bands, and each of the multiple frequency bands of the digital input signal are convolved with a second time slice of the impulse response using an equal number of direct convolution filters. The outputs of the equal number of direct convolution filters are recombined and a delay compensation is applied to the recombined outputs. An output of the direct convolution filter is summed with the delayed and recombined outputs to form a zero-to-near-zero latency convolution output.

### BACKGROUND

Latency in a musician's audio output signal occurring during a live musical performance is intolerable. For example, musicians performing live music, e.g., in the genres of jazz, blues, rock and country music, frequently improvise and play off one another. Latency of any perceptible duration (e.g., from when a note on a guitar is played, then processed through a string of digital signal processor (DSP) based musical effects, pre-amplifier, amplifier and speaker modeling filters, and finally played back through an analog audio amplification system and heard by fellow musicians) undermines the creative synergies between the musicians performing live music in such genres.

Direct convolution is used as a time-domain method of directly calculating a convolution sum of an audio input signal and an impulse response (IR), but the resulting audio output signal is, typically, without latency for full length IRs. The general shortcoming with direct convolution involving full length IRs is that most DSPs do not have the required processing power and memory to perform direct convolution of digital input signals with full impulse response (e.g., long IRs having a large number of sample sizes) and less powerful processors cannot handle such calculations and will fail. For real-time musical performance audio applications this would require a processor that is excessively expensive. In an imperfect attempt to overcome this shortcoming, conventional impulse response modeling for guitar speakers involves truncating the sample length of the full impulse response of the speaker (i.e., truncated to some first number of samples) to make the use of conventional computer processors possible in digital modelers and the cost of digital modeling technology more affordable to musicians. But, this truncation introduces a significant and undesirable cost of its own. Convolution of an audio input signal with a truncated impulse response results in an audio output signal that suffers from inaccuracies in the resolution of certain frequencies of the speaker model. Truncation reduces low frequency resolution since the frequency resolution is Fs/N where Fs is sample rate and N is number of samples. Accordingly, this cost is especially apparent to the performing musician in mid-to-low frequencies where the digital model of the speaker will sound less authentic in comparison to an actual guitar speaker responding to an analog guitar signal.

Another audio signal processing convolution technique involves the use of the Fast Fourier Transform, or FFT, and is a frequency-domain convolution. Specifically, FFT convolution can be achieved by converting the audio input signal and impulse response into the frequency domain and multiplying the results. Once both the audio input signal and impulse response have been multiplied, they can be converted back to the time domain by Inverse Fourier Transform method (IFFT). FFT convolution achieves accurate results, but intolerable latency is introduced when employed in the processing of audio input signals with IRs of considerable length.

Multi-band convolution is a convolution technique where an input is divided into multiple frequency bands by a downsampler and each band is convolved at a decimated sampling rate. Specifically, the input is divided into multiple decimated bands and direct convolution is performed on the separate bands by dedicated convolution filters. Each band is then interpolated back to the native sample rate by an upsampler and added together to obtain, as a final result, an audio output signal. This multiband direct convolution technique reduces the performance requirements of DSPs in comparison to full-band direct convolution techniques. The actual reduction, however, will be less due to the need to decimate and interpolate each band thereby introducing latency due to the finite causal filters required for their implementation.

The general shortcoming with the FFT and multi-band approaches lies in the inherent latency introduced. For example, the typical multi-band approach introduces latency due to the decimation and interpolation operations required for each band. Due to the stringent filter requirements this latency can be considerable although not as severe as FFT block convolution. And for certain applications, particularly those involving filtering of signals generated by a musical performance, the latency is unacceptable. For example, guitar players are particularly sensitive to any additional latency introduced into the playback system.

### SUMMARY

The subject matter described herein relates to digital modeling technology for musical performance. More specifically, the subject matter described herein relates to the efficient digital time-domain convolution processing of an audio input signal created during a musical performance with an impulse response (IR), e.g., an IR of a particular guitar speaker (or a speaker-cabinet combination), for creation of a high resolution audio output signal for immediate playback (during the performance) with zero to near-zero perceptible latency using a combination of direct and multi-band convolution algorithms.

The zero to near-zero latency convolution of the disclosed technology overcomes latency issues by dividing an impulse response into two or more time slices. The first time slice of the impulse response is convolved at the full native sample rate of the audio signal using direct convolution techniques and therefore incurs no latency. The subsequent time slices of the impulse response can be convolved using a multi-band convolution technique at reduced sample rates thereby requiring fewer operations per second. Each of the subsequent slices can be divided into frequency bands and processing performed on each audio band and the results added. The multiband convolution result can then be time-aligned and added into the direct convolution result to obtain a high resolution audio output signal having zero to near-zero latency.

One aspect of the disclosure provides a method of processing a digital input signal, comprising dividing, with one or more processors, an impulse response associated with a filter used for processing the digital input signal into two or more time slices. The one or more processors convolve the digital input signal at full bandwidth with a first time slice of the impulse response, and in parallel perform one of multi-band processing and reduced bandwidth convolution on the digital input signal using at least a second time slice of the two or more time slices, and compensate a delay of the parallel-processed digital signal. The method further includes summing the digital signal convolved with the first time slice and the delay-compensated parallel-processed digital signal, and outputting the summed signal to an external device.

The multi-band processing may include dividing, with the one or more processors, the digital input signal into multiple frequency bands. For each of the multiple frequency bands of the digital input signal, the one or more processors convolve the frequency band with a subsequent time slice of the impulse response. Further, the multi-band processing includes recombining, with the one or more processors, the convolved multiple frequency bands.

The reduced-bandwidth convolution may include decimating the digital signal by a given value, convolving the decimated signal with the second time slice, and interpolating the convolved signal by the given value.

Another aspect of the disclosure provides a system for processing a digital input signal, comprising a memory, and one or more processors in communication with the memory. The one or more processors are programmed to divide an impulse response associated with a filter used for processing the digital input signal into two or more time slices, convolve the digital input signal at full bandwidth with a first time slice of the impulse response, in parallel with the convolution, perform one of multi-band processing and reduced bandwidth convolution on the digital input signal using at least a second time slice of the two or more time slices, compensate a delay of the parallel-processed digital signal, sum the digital signal convolved with the first time slice and the delay-compensated parallel-processed digital signal, and output the summed signal to an external device. The system may further include a first convolution filter for convolving the digital input signal at full bandwidth with a first time slice of the impulse response uses, and at least a second convolution filter for convolving each of multiple frequency bands with a subsequent time slice of the impulse response comprises using. Moreover, analog-to-digital converter may be configured to receive an analog signal from a musical instrument and output the digital input signal.

Yet another aspect of the disclosure provides a non-transitory computer-readable storage medium storing instructions executable by one or more processors for performing a method of processing a digital input signal. The method comprises dividing an impulse response associated with a filter used for processing the digital input signal into two or more time slices, convolving the digital input signal at full bandwidth with a first time slice of the impulse response, in parallel with the convolution, performing one of multi-band processing and reduced bandwidth convolution on the digital input signal using at least a second time slice of the two or more time slices, compensating a delay of the parallel-processed digital signal, summing the digital signal convolved with the first time slice and the delay-compensated parallel-processed digital signal, and outputting the summed signal to an external device.

### BRIEF DESCRIPTION OF THE DRAWINGS

FIG. 1 is a block diagram of an example system according to aspects of the disclosure;

FIG. 2 is a block diagram of an example convolution system according to aspects of the disclosure;

FIG. 3 is a block diagram of another example convolution system according to aspects of the disclosure;

FIG. 4 is a block diagram of an example of a convolution system according to aspects of the disclosure;

FIG. 5 is a block diagram of an example of a convolution system according to aspects of the disclosure; and

FIG. 6 is a flow diagram of an example method according to aspects of the disclosure.

### DETAILED DESCRIPTION

The subject matter described herein relates to providing zero to near-zero latency convolution using a combination of direct and multi-band convolution algorithms. In some implementations, the zero-latency convolution of the disclosed technology performs a short, full-bandwidth direct convolution in parallel with one or more reduced-bandwidth (decimated) convolutions. More specifically, the zero-latency convolution of the disclosed technology overcomes latency issues by dividing the impulse response into two or more time slices. The first time slice is convolved at the full native sample rate of the audio signal using direct convolution techniques and therefore incurs no latency. The subsequent time slices of the impulse response can be convolved using a multi-band convolution technique at reduced sample rates thereby requiring fewer operations per second. Each of the subsequent slices can be divided into frequency bands and processing performed on each audio band and the results added. The multiband result can then be time-shifted and added with the direct convolution result to obtain an audio output signal having zero to near-zero latency.

According to some examples, only some of the divided frequency bands are processed. For example, later time slices need not process the full bandwidth and only need process some lower band of frequencies, which results in a further savings of processing power. Each later time slice can also have successively less bandwidth resulting in even further savings.

For a convolution filter whose impulse response is, e.g., 10,000 samples, to perform a direct convolution of an impulse response with an inputted audio signal would require approximately N² operations, where N is the number of samples. N=10,000 in this example. One common application of direct convolution in the digital modeling of guitar performance equipment lies in the area of guitar speaker impulse response emulation. Data for the impulse response of the speaker (or a speaker-cabinet combination) can be obtained through audio measurement and the data can be used in a convolution operation to simulate the sound of the speaker. This approach is extremely accurate though processing intensive, especially as the length of the IR increases. Many prior art techniques intentionally limit the length of the IR to minimize processing requirements while destroying frequency resolution.

Due to the unique statistics of guitar speaker cabinets, typical recording environments and the psychoacoustics of human hearing, loss of frequency resolution is far more apparent at low frequencies. Guitar speakers tend to have formants that are “constant-Q”, such that that the bandwidth of the formants is proportional to the frequency at which they occur. Furthermore human hearing is essentially logarithmic meaning that we have a “constant-Q” frequency resolution as well. Further still, the energy decay relief of a typical environment is such that the higher frequencies decay more rapidly than the lower frequencies.

In other words, high frequencies decay more quickly than low frequencies. For example, the lower strings on an instrument vibrate for a longer period of time than the upper strings. Again this is a “constant-Q” behavior. The strings vibrate for some number of cycles but time is inversely proportional to frequency so any given number of cycles is less time at higher frequencies. In theory, since guitar speakers produce a minimum-phase, or near-minimum-phase response to an input signal it implies that there is no adverse group delay associated with a particular formant. Therefore it can be assumed that the formant response “starts” rapidly after stimulation by an impulse.

Constant-Q can be used to reduce computational burdens. For example, if a formant has a time duration inversely proportional to its Q and also inversely proportional to frequency then the low frequency formants will have a time duration of much longer than the high frequency formants. For example, an impulse response may have a formant at 100 Hz and another formant at 10 KHz. Each of these formants has the same Q, meaning their bandwidth is the same as a percentage of the frequency. A formant produces an exponential response whose duration, for a given Q, is some number of cycles. Therefore the formant at 10 KHz will produce a damped oscillatory response that rings for some prescribed duration upon excitation by an impulse. The duration is inversely proportional to the frequency since the period is the inverse of the frequency. This implies that the formant at 100 Hz, assuming the same Q, will have a response 100 times longer.

The disclosed technology divides the impulse response into some number of smaller time slices. In some examples, these time slices overlap so as to prevent boundary problems when transitioning to lower bandwidth processing. A raised-cosine cross-fade can be employed to transition smoothly between time slices.

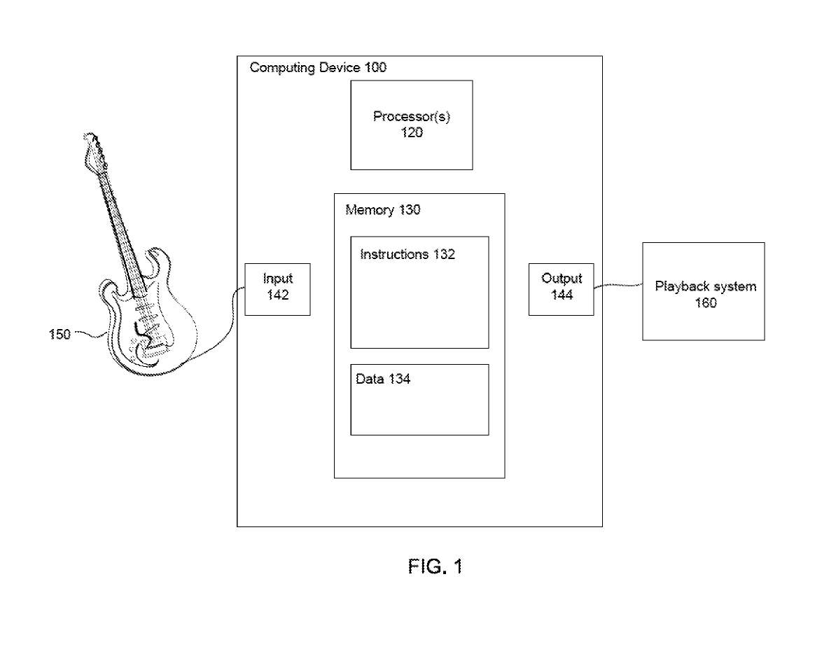

FIG. 1 illustrates an example system of a computing device 100 connected between a musical instrument and an external device. For example, the computing device 100 is connected to guitar 150 and playback system 160. The connections between the devices may include wires, cables, or any other type of connection. The playback system 160 may be a speaker cabinet, a mixer, a radio station public address, or any other device for emitting, transmitting, or further processing sound. In this regard, sound output by the guitar 150 is processed by the computing device 100 and output to the playback system 160 with near-zero latency.

Computing device 100 may contain a processor 120, memory 130 and other components typically present in general purpose computers. The computing device 100 may be, for example, one or more chips such as digital signal processors on a circuit board, a general purpose computer, an arrangement of interconnected computing devices, or the like. Moreover, the computing device 100 can be embedded in another device, such as a mobile telephone, a personal digital assistant (PDA), a mobile audio or video player, or a portable storage device (e.g., a universal serial bus (USB) flash drive).

Input 142 is configured to receive a signal from the guitar 150. The input may be a port in communication with the processor 120. In some examples, the input 142 includes an analog-to-digital converter configured to convert an analog signal received from the guitar 150 to a digital signal for use by the processor. Similarly, output 144 is configured to provide a signal to the playback system 160, and may include a digital-to-analog converter for transforming the processed digital signal back into analog form.

The processor 120 may be any processor suitable for the execution of a computer program including, by way of example, both general and special purpose microprocessors, a dedicated controller, such as an ASIC, or any one or more processors of any kind of digital computer. The processor 120 receives instructions 132 and data 134 from memory 130.

Memory 130 of computing device 100 stores information accessible by processor 120, including instructions 132 that may be executed by the processor 120. Memory also includes data 134 that may be retrieved, manipulated or stored by the processor. The memory may be of any type capable of storing information accessible by the processor, such as a hard-drive, memory card, ROM, RAM, DVD, CD-ROM, write-capable, and read-only memories. The memory 130 may include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The instructions 132 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. As described in further detail below, the instructions 132 may be executed to generate a scent profile based on first user input, generate a fragrance emission pattern based on at least one of the first user input and the scent profile, and update the scent profile and/or the first user input based on second user input.

Data 134 may be retrieved, stored or modified by processor 120 in accordance with the instructions 132. For instance, although the system and method is not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

The data 134 may include, for example, information related to filters used for processing signals output by the guitar 150. For example, the data 134 may include an impulse response of the filters. The impulse response may be divided into two or more time slices.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

Moreover, it should be understood that the computing device 100 is an illustrative example only. Implementations of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs. Alternatively or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The computing device 100 can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program can be written in any form of programming language and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Embodiments of the subject matter described herein can be implemented on mobile phones, smart phones, tablets, personal digital assistants, and computers having display devices, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, tactile feedback, etc.; and input from the user can be received in any form, including acoustic, speech, tactile input, etc. In addition, a computer can interact with a user by sending documents to and receiving documents from a device that is used by the user; for example, by sending web pages to a web browser on a user's client device in response to requests received from the web browser.

To compute the time slices, an original impulse response (IR), h(n), is analyzed and an appropriate duration is calculated for the full-bandwidth processing. In some implementations, the length of the second time slice could be longer than the first to exploit the reduced processing requirements necessary at lower sample rates, as described below. For example Ns might be 1000 samples while the residual h2(n) response would be from n=1000 to n=10,000. Naturally this concept can be extended to multiple time slices at successively higher decimation rates. For example, h1(n) might be a time slice from 0 to 500 samples, h2(n) might be a time slice from 500 to 2000 samples processed at ¼ sample rate, h3(n) might be from 2000 to 8000 samples processed at ⅛ sample rate.

The remaining IR is then faded to zero using a desired cross-fade function. For example, to apply a raised-cosine cross-fade, the first time slice would then be given by:

h1(n)=h(n)*w(n)

where w(n) is a window function such that the window is unity for some number of samples and then tapers to zero over some number of samples,

w(n)={1;n<Ns0.5+0.5*cos((n−Ns)*pi/M); otherwise

where Ns is the sample number to start tapering and M is the number of samples over which to taper.

The tapering operation results in an impulse response, h1(n), whose coefficients are all zero at n>Ns+M. Therefore the convolution operation need only be performed on Ns+M coefficients.

We then define a “residual” impulse response, h2(n), which is simply

h2(n)=h(n)−h1(n)

where this response has coefficients that are zero for n<Ns and then slowly fades in to the remaining coefficients in h(n) that are not present in h1(n).

The first Ns samples being zero in h2(n) allows a unique opportunity to process this “residual” response using multi-band techniques. The IR can be divided into any number of bands and processed at lower sample rates and then recombined. The operation is carried out in parallel with the processing of h1(n). Since the first Ns coefficients are zero these can be discarded and the processing only carried out on the non-zero samples. If the decimation and interpolation of each band had zero latency the results of the decimated processing would need to be delayed appropriately to compensate for the discarded zeros. A simple delay line is all that would be necessary. Since real decimation and interpolation processing introduces latency, the actual amount of delay is reduced by the added latency. Therefore our compensation filter would simply be z^{-k} where k is given by

k=Ns−d

where d is the delay incurred by downsampling and upsampling.

This paradigm can be extended to divide the time series into any number of slices. Each of these slices can be processed at a reduced sample rate and then added to the full-bandwidth result. Each slice requires a unique compensation delay.

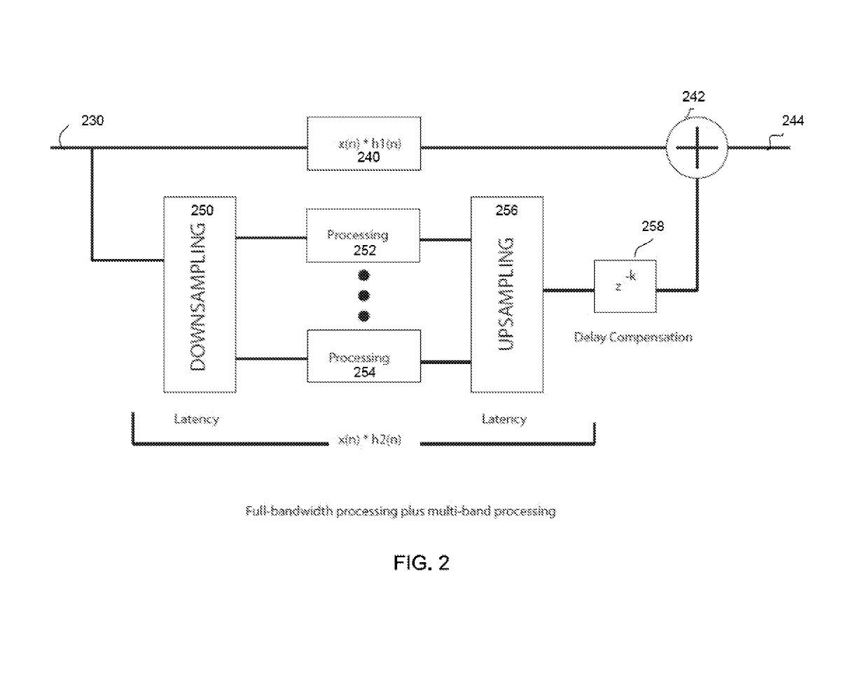

FIG. 2 shows full-bandwidth processing in combination with multi-band processing. Here, the IR is divided into two time slices. The first slice would have a duration of Ns+M samples and the second time slice would have a duration of the full length of the impulse response, but the first Ns samples would be zero where h2(n) is given by h(n)−h1(n). An audio digital signal 230 with a full native sample rate is transmitted to a direct convolution filter 240 where the full native sample rate is convolved with the first time slice of the IR. Simultaneously and in parallel, the audio signal 230 is also transmitted to a downsampler 250 and the signal is divided into multiple frequency bands. These frequency bands are each convolved with the second time slice of the IR in filters 252-254. While only two filters 252-254 are shown, it should be understood that any number of filters may be used according to a number of frequency bands for processing. For example, if the signal 230 is divided into five frequency bands, then five filters may be employed. The convolved multiple frequency bands are upsampled in upsampler 256, and recombined. The recombined and convolved signal is sent to a delay compensation filter 258 and then summed in calculator 242 with the output of the direct convolution filter, thereby computing a convolution signal 244 with zero to near zero latency.

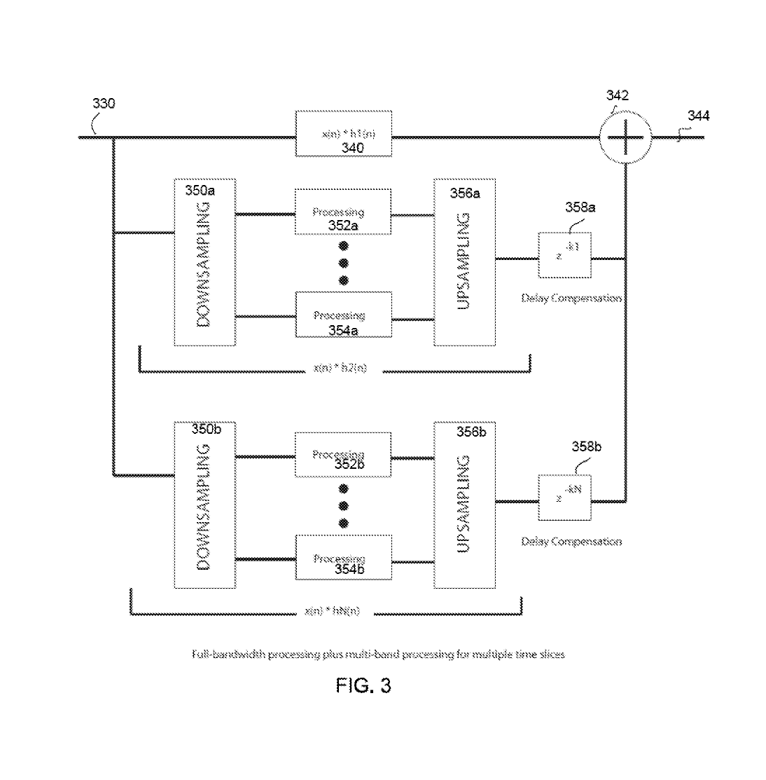

FIG. 3 shows full-bandwidth processing in combination with multi-band processing for multiple time slices. Here, the IR is divided into three or more time slices. The first slice would have a duration of Ns+M samples and the other time slices would have a duration computed by need. An audio digital signal 330 with a full native sample rate is transmitted to a direct convolution filter 340 where the full native sample rate is convolved with the first time slice of the IR. Simultaneously and in parallel, the audio signal is also transmitted to two or more downsamplers 350a, 350b (depending on the number of time slices) and the signals are divided into multiple frequency bands. These frequency bands are each convolved in filters 352a-354a, 352b-354b with the time slice associated with the downsamplers 350a, 350b. The results of each time slice are upsampled in upsampler 356a, 356b, recombined and time delayed by delay compensation filters 358a, 358b. The recombined and convolved signals are then summed in calculator 342 with the output of the direct convolution filter, thereby computing a convolution signal 344 with zero to near zero latency.

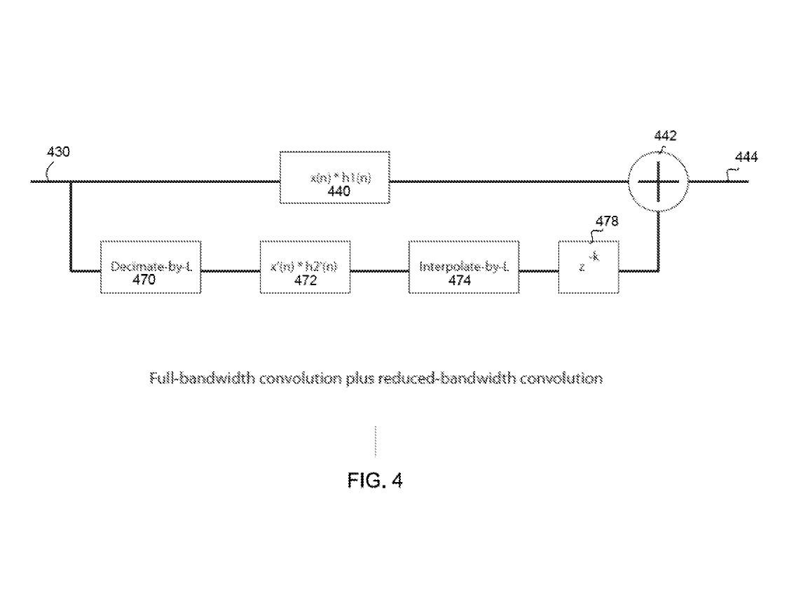

FIG. 4 shows full-bandwidth processing in combination with reduced bandwidth convolution. Here, the IR is divided into two time slices. The first slice would have a duration of Ns+M samples and the second time slice would have a duration of the full length of the impulse response but the first Ns samples would be zero where h2(n) is given by h(n)−h1(n). However, for the second time slice, only low frequencies are processed. Therefore, the impulse response h2′(n) is a decimated version of h2(n). Standard principles for decimating h2(n) apply, i.e. low-pass filtering followed by downsampling. Therefore, in use, a full-bandwidth IR is processed in parallel with a reduced bandwidth residual IR at a lower sample rate. The net result of this is to create a new impulse response that has the full bandwidth from 0 to Ns samples and then gradually transforms to a reduced bandwidth response beyond Ns. Since, as stated before, the low-frequency formants “ring” for a longer duration little actual information is lost. As shown in FIG. 4, an audio digital signal 430 with a full native sample rate is transmitted to a direct convolution filter 440 where the full native sample rate is convolved with the first time slice of the IR. Simultaneously and in parallel, the audio signal 430 is decimated by decimator 470 by L. The decimated signal is convolved with a decimated second time slice of the IR in filter 472. The result is interpolated by L, for example, in an interpolation module 474. The interpolated and convolved signal is sent to a delay compensation filter 478 and then summed in calculator 442 with the output of the direct convolution filter, thereby computing a convolution signal 444 with zero to near zero latency.

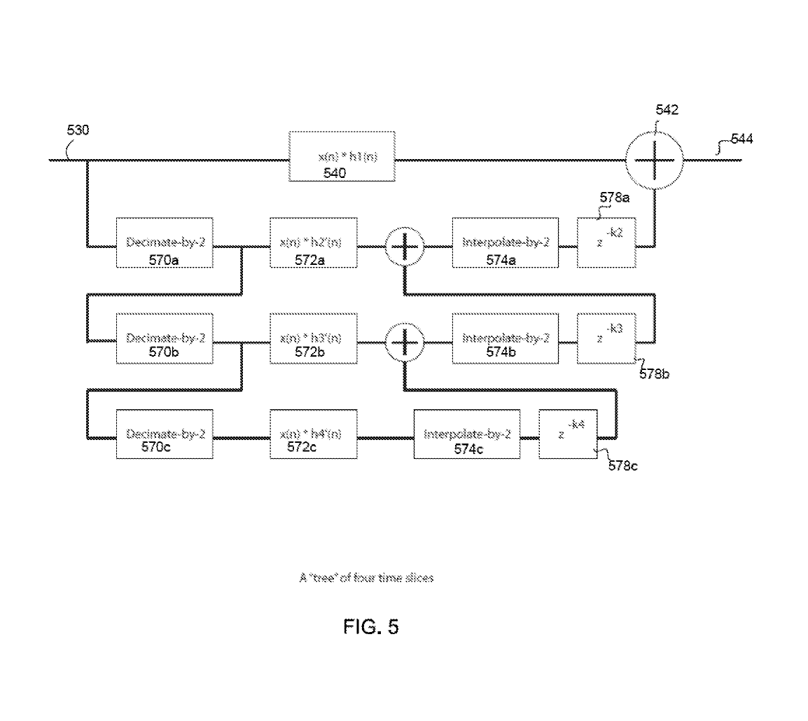

As shown in FIG. 5, redundancy can be exploited such that a decimation and interpolation “tree” is formed. The output of each decimator is in turn decimated and a decimated convolution is computed. The result is interpolated and summed with the previous time slice's result. The resulting processing can be written as

y(n)=x(n)*h1(n)+x(n)*h2′(n)+x(n)*h3′(n)+ . . .

where h2′(n), for example, indicates a decimated version of the second time slice.

As shown in FIG. 5, an audio digital signal 90 with a full native sample rate is transmitted to a direct convolution filter 94 where the full native sample rate is convolved with the first time slice of the IR. Simultaneously and in parallel, the audio signal 530 is spilt and decimated by decimators 570a-c by 2. The decimated signals are convolved with a number of decimated time slices of the IR in filters 572a-c. The result of the highest number time slice filter 572c is interpolated by 2 in an interpolator 574c and time delayed by filer 578c. The resultant is added to the resultant of filter 572b. This resultant is interpolated by 574b, time delayed by filter 578b and added to the resultant of filter 572a. This resultant is interpolated by 2 by 574a and time delayed by filter 578a. The final interpolated and convolved signal is sent summed in calculator 542 with the output of the direct convolution filter, thereby computing a convolution signal 544 with zero to near zero latency.

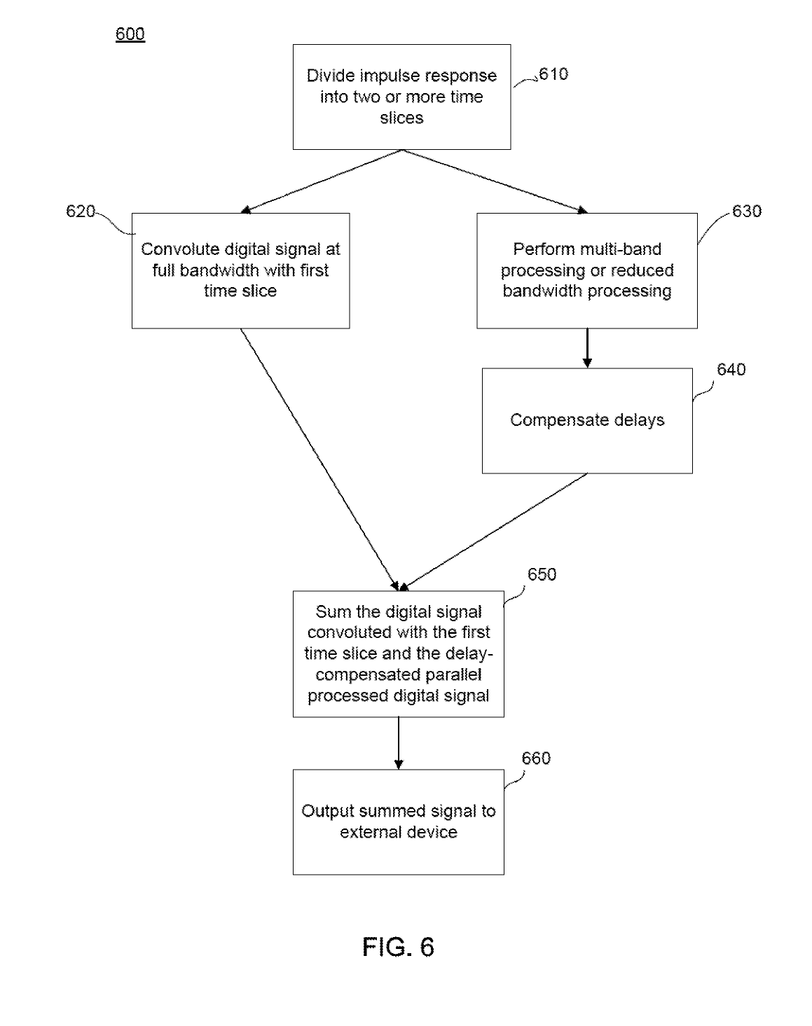

FIG. 6 provides an example flow diagram 600 illustrating a method of processing a signal from a first device, such as a musical instrument, for providing to a second device, such as a playback system. The method may be performed by, for example, one or more processors such as described in connection with FIG. 1. While the operations are described in a particular order, the operations may be executed in a different order or particular operations may be executed simultaneously. Moreover, operations may be added or omitted.

In block 610, an impulse response associated with a filter for processing a digital signal is divided into two or more time slices. In block 620, the digital signal is convolved at full bandwidth with a first time slice of the two or more time slices.

In block 630, the digital signal is parallel processed with the full-bandwidth processing. In particular, multi-band processing or reduced bandwidth processing may be performed. In multi-band processing, the digital input signal is divided into multiple frequency bands, for example, by a downsampler. For each of the multiple frequency bands of the digital input signal, the frequency band is convolved with a subsequent time slice of the impulse response. The convolved multiple frequency bands are then recombined, for example, by an upsampler. The reduced-bandwidth convolution may include decimating the digital signal by a given value, convolving the decimated signal with the second time slice, and interpolating the convolution signal by the given value.

In block 640, delays resulting from the multi-band or reduced-bandwidth processing are compensated. For example, any of a number of delay-compensation techniques may be used.

In block 650, the results of blocks 620 and 640 are summed. The output of the summation is provided to an external device, such as the playback system, in block 660.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the embodiments described above should not be understood as requiring such separation in all embodiments, and it should be understood that the described program components and systems can generally be integrated together in a single software product or packaged into multiple software products.

The signal processing described above is advantageous in that, for example, it enhances the spectral resolution of an impulse response by avoiding the truncation commonly employed in guitar speaker modeling. Moreover, it provides the frequency detail of a very long impulse response with little or no added processing burden or storage requirements. A relatively inexpensive digital signal processor may be employed to produce a high-resolution direct convolution audio output signal having zero or near-zero latency. Enhanced resolution across the entire frequency spectrum results in a more realistic and authentic musical experience for the performing musician because the digitally modeled speaker performs more like its real-world analog equivalent. The enhanced resolution also results in a more inspired performance by a musician utilizing the subject matter disclosed and a better musical experience for those performing with, and listening to, the musician.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of processing a digital input signal, comprising:
dividing, with one or more processors, an impulse response associated with a filter used for processing the digital input signal into two or more time slices;
convolving, with one or more processors, the digital input signal at full bandwidth with a first time slice of the impulse response;
in parallel with the convolution, performing, using the one or more processors, one of multi-band processing and reduced bandwidth convolution on the digital input signal using at least a second time slice of the two or more time slices;
compensating, with the one or more processors, a delay of the parallel-processed digital signal;
summing the digital signal convolved with the first time slice and the delay-compensated parallel-processed digital signal; and
outputting the summed signal to an external device.

2. The method of claim 1, wherein the multi-band processing comprises:
dividing, with the one or more processors, the digital input signal into multiple frequency bands;
for each of the multiple frequency bands of the digital input signal, convolving, with the one or more processors, the frequency band with a subsequent time slice of the impulse response; and
recombining, with the one or more processors, the convolved multiple frequency bands.

3. The method of claim 2, wherein dividing the digital input signal into multiple frequency bands comprises downsampling the digital input signal.

4. The method of claim 2, wherein recombining the convolved multiple frequency bands comprises upsampling the convolved multiple frequency bands.

5. The method of claim 2, further comprising:
dividing the digital input signal into at least two sets of multiple frequency bands; and
convolving each of the at least two sets of multiple frequency bands with subsequent time slices.

6. The method of claim 2, wherein:
convolving the digital input signal at full bandwidth with a first time slice of the impulse response uses a first convolution filter; and
convolving each of the multiple frequency bands with a subsequent time slice of the impulse response comprises using at least a second convolution filter.

7. The method of claim 1, wherein performing the reduced-bandwidth convolution comprises:
decimating the digital signal by a given value;
convolving the decimated signal with the second time slice; and
interpolating the convolved signal by the given value.

8. The method of claim 1, further comprising receiving the digital input signal from a musical instrument.

9. The method of claim 8, wherein the received digital signal is an analog signal from the musical instrument, and further comprising converting the analog signal to the digital signal using an analog-to-digital converter.

10. A system for processing a digital input signal, comprising:
a memory; and
one or more processors in communication with the memory, the one or more processors programmed to:
divide an impulse response associated with a filter used for processing the digital input signal into two or more time slices;
convolve the digital input signal at full bandwidth with a first time slice of the impulse response;
in parallel with the convolution, perform one of multi-band processing and reduced bandwidth convolution on the digital input signal using at least a second time slice of the two or more time slices;
compensate a delay of the parallel-processed digital signal;
sum the digital signal convolved with the first time slice and the delay-compensated parallel-processed digital signal; and
output the summed signal to an external device.

11. The system of claim 10, wherein in the multi-band processing, the one or more processors are further programmed to:
divide the digital input signal into multiple frequency bands;
for each of the multiple frequency bands of the digital input signal, convolve the frequency band with a subsequent time slice of the impulse response; and
recombine the convolved multiple frequency bands.

12. The system of claim 11, wherein dividing the digital input signal into multiple frequency bands comprises downsampling the digital input signal.

13. The system of claim 11, wherein recombining the convolved multiple frequency bands comprises upsampling the convolved multiple frequency bands.

14. The system of claim 11, wherein the one or more processors are further programmed to:
divide the digital input signal into at least two sets of multiple frequency bands; and
convolve each of the at least two sets of multiple frequency bands with subsequent time slices.

15. The system of claim 11, further comprising:
a first convolution filter for convolving the digital input signal at full bandwidth with a first time slice of the impulse response uses; and
at least a second convolution filter for convolving each of the multiple frequency bands with a subsequent time slice of the impulse response.

16. The system of claim 10, wherein in performing the reduced-bandwidth convolution the one or more processors are further configured to:
decimate the digital signal by a given value;
convolve the decimated signal with the second time slice; and
interpolate the convolved signal by the given value.

17. The system of claim 10, further comprising an analog-to-digital converter configured to receive an analog signal from a musical instrument and output the digital input signal.

18. A non-transitory computer-readable storage medium storing instructions executable by one or more processors for performing a method of processing a digital input signal, the method comprising:
dividing an impulse response associated with a filter used for processing the digital input signal into two or more time slices;
convolving the digital input signal at full bandwidth with a first time slice of the impulse response;
in parallel with the convolution, performing one of multi-band processing and reduced bandwidth convolution on the digital input signal using at least a second time slice of the two or more time slices;
compensating a delay of the parallel-processed digital signal;
summing the digital signal convolved with the first time slice and the delay-compensated parallel-processed digital signal; and
outputting the summed signal to an external device.

19. The non-transitory computer-readable storage medium of claim 18, wherein the multi-band processing comprises:
dividing the digital input signal into multiple frequency bands;
for each of the multiple frequency bands of the digital input signal, convolving, with the one or more processors, the frequency band with a subsequent time slice of the impulse response; and
recombining the convolved multiple frequency bands.

20. The non-transitory computer-readable storage medium of claim 18, wherein performing the reduced-bandwidth convolution comprises:
decimating the digital signal by a given value;
convolving the decimated signal with the second time slice; and
interpolating the convolved signal by the given value.
